(19) United States
(12) Patent Application Publication
(10) Pub. No.: US 2022/0053377 A1
(43) Pub. Date: Feb. 17, 2022

(54) Handling of QoS Errors in ESM Procedure

(71) Applicant: MEDIATEK INC., Hsin-Chu (TW)

(72) Inventors: Chien-Chun Huang-Fu, Hsin-Chu (TW); Shang-Ru Mo, Hsin-Chu (TW); Chi-Hsien Chen, Hsin-Chu (TW)

(21) Appl. No.: 17/374,309

(22) Filed: Jul. 13, 2021

Related U.S. Application Data
(60) Provisional application No. 63/064,992, filed on Aug. 13, 2020.

(51) Int. Cl. H04W 28/08; H04W 28/26; H04W 28/04

(52) U.S. Cl. CPC H04W 28/0967; H04W 28/04; H04W 28/26

(57) ABSTRACT

A method of handling QoS error in an evolved packet system (EPS) session management (ESM) procedure to support interworking from EPS to 5G system (5GS) is proposed. A UE receives 5GSM parameters of QoS rule(s) and/or QoS flow description(s) included in a PCO/ePCO IE in an ESM message for performing a QoS operation. During the ESM procedure, only 5G QoS parameters related to the current EPS bearer been activated or modified are allocated and sent to the UE via PCO/ePCO. Otherwise, an operation error may occur for the QoS operation. Accordingly, the operation error is detected by the UE before intersystem change from S1 mode to N1 mode happens and the UE indicates such error to the network with a cause value.

### CROSS REFERENCE TO RELATED APPLICATIONS

This application claims priority under 35 U.S.C. § 119 from U.S. Provisional Application No. 63/064,992, entitled “Handling of QoS Errors in ESM Procedure”, filed on Aug. 13, 2020, the subject matter of which is incorporated herein by reference.

### TECHNICAL FIELD

The disclosed embodiments relate generally to wireless communication, and, more particularly, to method of handling QoS errors in EPS session management (ESM) procedure for interworking between 4G evolved packet system (EPS) and 5G system (5GS).

### BACKGROUND

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. The Next Generation Mobile Network (NGMN) board, has decided to focus the future NGMN activities on defining the end-to-end requirements for 5G new radio (NR) systems (5GS).

In 4G evolved packet system (EPS), a Packet Data Network (PDN) connectivity procedure is an important process when LTE communication system accesses to the packet data network. The purpose of PDN connectivity procedure is to setup a default EPS bearer between a UE and the packet data network. In 5G, a Protocol Data Unit (PDU) session establishment is a parallel procedure of the PDN connectivity procedure in 4G. A PDU session defines the association between the UE and the data network that provides a PDU connectivity service. Each PDU session is identified by a PDU session ID (PSI), and may include multiple QoS flows and QoS rules. In LTE EPS, QoS is managed based on EPS bearer in the Evolved Packet Core (EPC) and the Radio Access Network (RAN). In 5G network, QoS flow is the finest granularity for QoS management to enable more flexible QoS control.

The concept of QoS flow in 5G is like EPS bearer in 4G. When a QoS flow is added, the network can provide a QoS flow description IE to the UE, which comprises a list of QoS flow descriptions. Each QoS flow description comprises a QoS flow identifier (QFI), a QoS flow operation code, a number of QoS flow parameters, and a QoS flow parameters list. Each parameter included in the parameters list consists of a parameter identifier that identifies the corresponding parameter. One of the parameter identifiers is the EPS bearer identity (EBI), which is used to identify the EPS bearer that is mapped to or associated with the QoS flow. Each QoS rule is identified by a QoS rule ID (QRI). There can be one or more than one QoS rules associated with the same QoS flow.

A QoS operation can be performed via a PDU session modification procedure (via PDU session modification command message) in 5G NR networks or an EPS session management (ESM) procedure (via EPS bearer context request message) in 4G LTE networks. Interworking from EPS to 5GS is supported for a PDN connection if the corresponding EPS bearer context is received by a Protocol configuration options IE or Extended protocol configuration options IE (PCO/ePCO IE). During the ESM procedure, as a general principle, only 5G QoS parameters related to the current EPS bearer been activated or modified are allocated and sent to the UE via PCO/ePCO. Otherwise, an error may occur for the ESM operation. The error operation should be detected by the UE before intersystem change from S1 mode to N1 mode happens and the UE should indicate such error to the network.

### SUMMARY

A method of handling QoS error in evolved packet system (EPS) session management (ESM) procedure to support interworking from EPS to 5G system (5GS) is proposed. A QoS operation can be performed by an ESM procedure in 4G LTE networks, e.g., the EPS bearer context is received by a Protocol configuration options IE or Extended protocol configuration options IE (PCO/ePCO IE) in an ESM message. UE receives 5GSM parameters of QoS rule(s) and/or QoS flow description(s) included in the PCO/ePCO IE in the ESM message, which include ACTIVATE DEFAULT EPS BEARER CONTEXT REQUEST, or ACTIVATE DEDICATED EPS BEARER CONTEXT REQUEST, or MODIFY EPS BEARER CONTEXT REQUEST message, for performing the QoS operation. During the ESM procedure, only 5G QoS parameters related to the current EPS bearer been activated or modified are allocated and sent to the UE via PCO/ePCO. Otherwise, an operation error may occur for the QoS operation. Accordingly, the operation error is detected by the UE before intersystem change from S1 mode to N1 mode happens and the UE indicate such error to the network with a cause value.

In one embodiment, a UE maintains a Packet data network (PDN) connection in evolved packet system (EPS). The PDN connection comprises a first and a second evolved packet system (EPS) bearers. The UE receives an EPS session management (ESM) message with 5GSM parameters from the network. The ESM message is for performing a QoS operation on a QoS rule for the first EPS bearer. The UE determines a resultant QoS rule resulted from the performing the QoS operation. The resultant QoS rule is related to the second EPS bearer. The UE indicates a QoS operation error with a cause value to the network when the QoS operation error is to be caused.

In one embodiment, the QoS operation is to modify or delete an existing QoS flow, however, the existing QoS flow is stored for another EPS bearer context different from the EPS bearer context being modified. In another embodiment, the QoS operation is to create or modify or delete a QoS rule, however, the resultant QoS rule is associated with another EPS bearer context different from the EPS bearer context being modified. In yet another embodiment, the QoS operation is to create new QoS rule having a QRI, however, there is already an existing QoS rule with the same QRI stored for an EPS bearer context different from the EPS bearer context being activated and belonging to the same PDN connection as the EPS bearer context being activated.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G/4G network and a Packet Data Network (PDN) connection handling QoS error during Evolved packet system (EPS) session management (ESM) procedure in accordance with one novel aspect.

FIG. 2 illustrates simplified block diagrams of a user equipment (UE) and a network entity in accordance with embodiments of the current invention.

FIG. 3 is a message sequence chart between a UE and a 4G and 5G network for handling QoS errors during ESM procedure in accordance with one novel aspect.

FIG. 4 illustrates one embodiment of QoS flow description identified by a QFI as well as a QoS rule comprising a QoS rule identifier (QRI) and a QoS flow identifier (QFI).

FIG. 5 illustrates embodiments of detecting various QoS operation errors during an ESM procedure and corresponding UE behavior.

FIG. 6 is a flow chart of a method of handling QoS operation error during an ESM procedure from a user equipment (UE) perspective in accordance with one novel aspect.

### DETAILED DESCRIPTION

Reference will now be made in detail to some embodiments of the invention, examples of which are illustrated in the accompanying drawings.

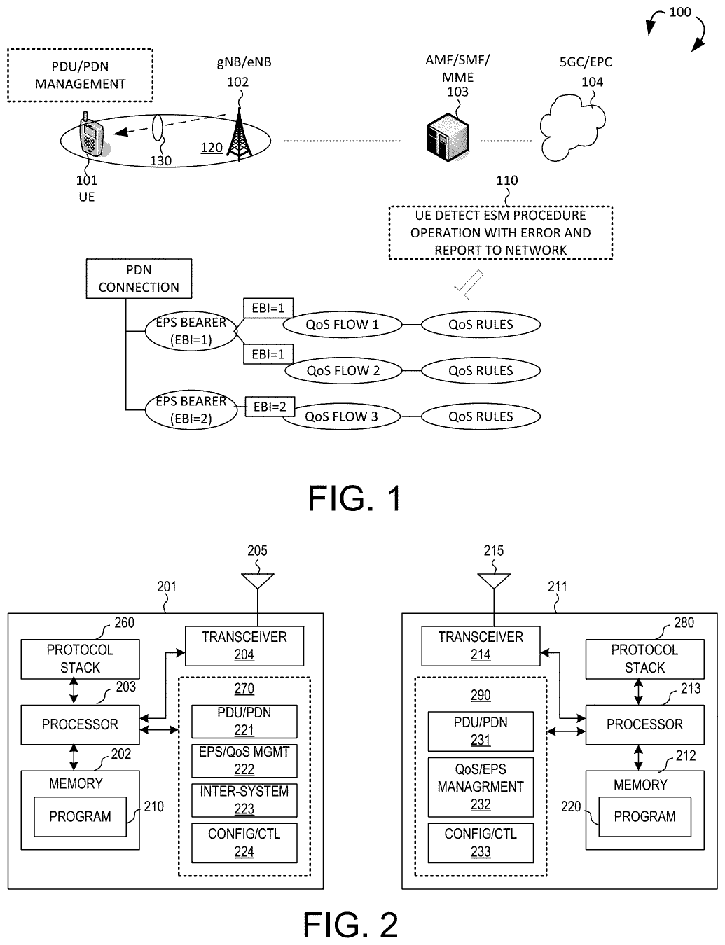

FIG. 1 illustrates an exemplary 5G/4G network 100 and a Packet Data Network (PDN) connection handling QoS error during Evolved packet system (EPS) session management (ESM) procedure in accordance with one novel aspect. 5G new radio (NR) network 100 comprises a user equipment UE 101, a base station gNB/eNB 102, an access and Mobility Management Function (AMF)/Session Management Function (SMF) 103, and a 5G/4G core network 5GC/EPC 104. In the example of FIG. 1, UE 101 and its serving base station gNB 102 belong to part of a radio access network RAN 120. In Access Stratum (AS) layer, RAN 120 provides radio access for UE 101 via a radio access technology (RAT). In Non-Access Stratum (NAS) layer, AMF/SMF 103 communicates with gNB 102 and 5GC 104 for access and mobility management and PDU session management of wireless access devices in 5G network 100. UE 101 may be equipped with a radio frequency (RF) transceiver or multiple RF transceivers for different application services via different RATs/CNs. UE 101 may be a smart phone, a wearable device, an Internet of Things (IoT) device, and a tablet, etc.

5GS networks are packet-switched (PS) Internet Protocol (IP) networks. This means that the networks deliver all data traffic in IP packets, and provide users with Always-On IP Connectivity. When UE joins a 5GS network, a Packet Data Network (PDN) address (i.e., the one that can be used on the PDN) is assigned to the UE for its connection to the PDN. In 4G, a PDN connectivity procedure is to setup a Default EPS Bearer between a UE and the packet data network. EPS has defined the Default EPS Bearer to provide the IP Connectivity that is Always-On. In 5G, a Protocol Data Unit (PDU) session establishment procedure is a parallel procedure of a PDN connectivity procedure in 4G. A PDU session defines the association between the UE and the data network that provides a PDU connectivity service. Each. PDU session is identified by a PUD session ID (PSI), and may include multiple QoS flows and QoS rules. In 5G network, QoS flow is the finest granularity for QoS management to enable more flexible QoS control.

The concept of QoS flow in 5G is like the EPS bearer context in 4G. When a QoS flow is added, the network can provide a QoS flow description IE to the UE, which comprises a list of QoS flow descriptions. Each QoS flow description comprises a QFI, a QoS flow operation code, a number of QoS flow parameters, and a QoS flow parameters list. Each parameter included in the parameters list consists of a parameter identifier that identifies the parameter. One of the parameter identifiers is the EPS bearer identity (EBI), which is used to identify the EPS bearer that is mapped to or associated with the QoS flow. When a QoS flow is deleted, all the associated EPS bearer context information that are mapped from the deleted QoS flow should be deleted from the UE and the network. Each QoS rule is identified by a QoS rule ID (QRI). There can be one or more than one QoS rules associated with the same QoS flow.

A QoS operation can be performed by an EPS session management (ESM) procedure (via EPS bearer context request message) in 4G LTE networks, e.g., the EPS bearer context is received by a Protocol configuration options IE or Extended protocol configuration options IE (PCO/ePCO IE). During the ESM procedure, as a general principle, only 5G QoS parameters related to the current EPS bearer been activated or modified are allocated and sent to the UE via PCO/ePCO. Otherwise, an error may occur for the ESM operation. The error operation should be detected by the UE before intersystem change from S1 mode to N1 mode happens and the UE should indicate such error to the network. In the example of FIG. 1, UE 101 establishes a PDN connection, which has a first EPS bearer (EBI=1) and a second EPS bearer (EBI=2). EBI1 is configured with QoS flow 1 (QFI=1) and QoS flow 2 (QFI=2), and EBI2 is configured with QoS flow 3 (QFI=3). Each QoS flow is configured with one or more QoS rules.

In accordance with one novel aspect, the following ESM operations should be detected by UE 101 as error cases, and UE 101 reports the error to the network by including corresponding cause value, as depicted by 110. In a first embodiment, UE 101 is to modify or delete an existing QoS flow, but the existing QoS flow is stored for another EPS bearer context. For example, ESM procedure on EBI1 tries to modify a QoS flow with QFI=3 associated with EBI2. In a second embodiment, UE 101 is to create, modify, or delete a QoS rule for one EPS bearer, but the resultant QoS rule is associated with another EPS bearer. For example, ESM procedure on EBI1 tries to modify a QoS rule of QFI1 and changing QFI1 to QFI3 associated with EBI2. In a third embodiment, UE 101 is to create a new QoS rule and there is already an existing QoS rule with the same QoS rule identifier (QRI) stored for an EPS bearer context different from the EPS bearer context being activated and belonging to the same PDN connection as the EPS bearer context being activated. For example, a QoS rule with QRI=5 already exist with EBI2, and ESM procedure on EBI1 tries to create a new QoS rule with QRI=5.

FIG. 2 illustrates simplified block diagrams of wireless devices, e.g., a UE 201 and a network entity 211 in accordance with embodiments of the current invention. Network entity 211 may be a base station and/or an AMF/SMF. Network entity 211 has an antenna 215, which transmits and receives radio signals. A radio frequency RF transceiver module 214, coupled with the antenna, receives RF signals from antenna 215, converts them to baseband signals and sends them to processor 213. RF transceiver 214 also converts received baseband signals from processor 213, converts them to RF signals, and sends out to antenna 215. Processor 213 processes the received baseband signals and invokes different functional modules to perform features in base station 211. Memory 212 stores program instructions and data 220 to control the operations of base station 211. In the example of FIG. 2, network entity 211 also includes protocol stack 280 and a set of control functional modules and circuit 290. PDU session and PDN connection handling circuit 231 handles PDU/PDN establishment and modification procedures. QoS and EPS bearer management circuit 232 creates, modifies, and deletes QoS and EPS bearers for UE. Configuration and control circuit 233 provides different parameters to configure and control UE of related functionalities including mobility management and PDU session management.

Similarly, UE 201 has memory 202, a processor 203, and radio frequency (RF) transceiver module 204. RF transceiver 204 is coupled with antenna 205, receives RF signals from antenna 205, converts them to baseband signals, and sends them to processor 203. RF transceiver 204 also converts received baseband signals from processor 203, converts them to RF signals, and sends out to antenna 205. Processor 203 processes the received baseband signals and invokes different functional modules and circuits to perform features in UE 201. Memory 202 stores data and program instructions 210 to be executed by the processor to control the operations of UE 201. Suitable processors include, by way of example, a special purpose processor, a digital signal processor (DSP), a plurality of micro-processors, one or more micro-processor associated with a DSP core, a controller, a microcontroller, application specific integrated circuits (ASICs), file programmable gate array (FPGA) circuits, and other type of integrated circuits (ICs), and/or state machines. A processor in associated with software may be used to implement and configure features of UE 201.

UE 201 also comprises a set of functional modules and control circuits to carry out functional tasks of UE 201. Protocol stacks 260 comprise Non-Access-Stratum (NAS) layer to communicate with an AMF/SMF/MME entity connecting to the core network, Radio Resource Control (RRC) layer for high layer configuration and control, Packet Data Convergence Protocol/Radio Link Control (PDCP/RLC) layer, Media Access Control (MAC) layer, and Physical (PHY) layer. System modules and circuitry 270 may be implemented and configured by software, firmware, hardware, and/or combination thereof. The function modules and circuits, when executed by the processors via program instructions contained in the memory, interwork with each other to allow UE 201 to perform embodiments and functional tasks and features in the network. In one example, system modules and circuitry 270 comprise PDU session and PDN connection handling circuit 221 that performs PDU session and PDN connection establishment and modification procedures with the network, an EPS bearer and QoS management circuit 222 that manages, creates, modifies, and deletes mapped EPS bearer contexts and mapped 5GSM QoS Flow and QoS Rule parameters, an inter-system handling circuit 223 that handles inter-system change functionalities, and a config and control circuit 224 that handles configuration and control parameters for mobility management and session management. In one example, a QoS operation error during an ESM procedure is detected by the UE before intersystem change from EPS to 5GS, and the UE indicate such error to the network with a cause value.

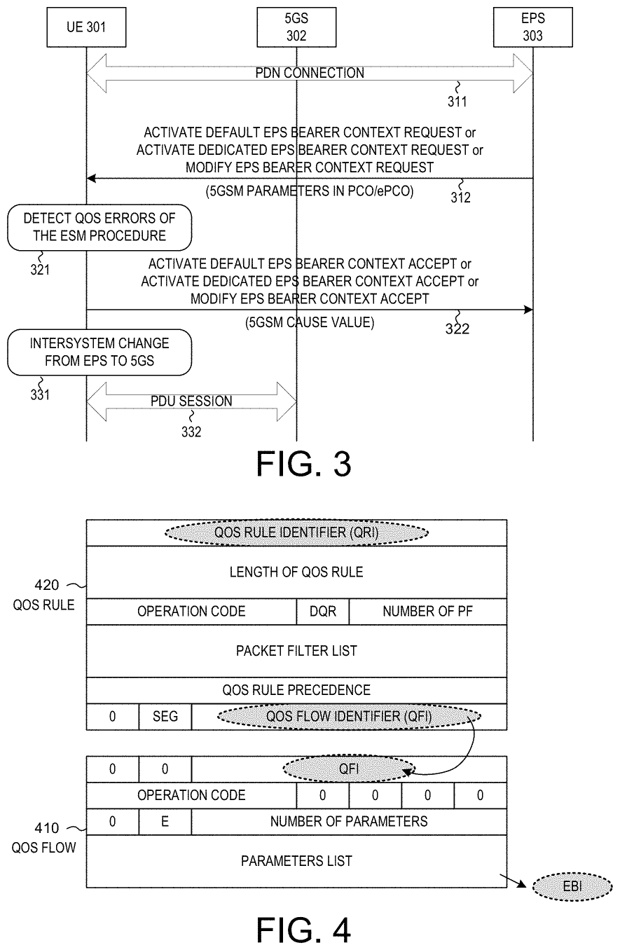

FIG. 3 is a message sequence chart between a UE and a 4G and 5G network for handling QoS errors during ESM procedure in accordance with one novel aspect. In step 311, UE 301 maintains a PDN connection with EPS network 303. In step 312, UE 301 receives an extended Protocol Configuration Options (ePCO)/PCO IE in an ESM message that carries 5GSM parameters including a list of QoS flow descriptions and/or a list of QoS rules from EPS network 303 during an ESM procedure that triggers a QoS operation. In one example, the ePCO/PCO IE may be contained in an activate default EPS bearer context request message or in an activate dedicated EPS bearer context request message during an EPS bearer activation procedure of the PDN connection—to create a new QoS flow or to create a new QoS rule. In another example, the ePCO/PCO IE may be contained in a modify EPS bearer context request message during an EPS bearer modification procedure of a PDN connection—to modify an existing QoS flow or to modify an existing QoS rule.

In step 321, UE 301 detects whether the ESM procedure may trigger any potential error due to the QoS operation. In step 322, if no errors are detected, then in response to the request message, UE 301 sends an activate default EPS bearer context accept message, an activate dedicated EPS bearer context accept message, or an modify EPS bearer context accept message to network 303. However, if error is detected, then UE 301 indicates the error with corresponding cause value, e.g., semantic error in the QoS operation. In step 331, UE 301 performs inter-system change from EPS to 5GS. In step 332, the PDN connection is transferred to the corresponding PDU session, and the EPS bear contexts of the EPS bearers are mapped to QoS flows based on the 5GSM parameters. Note that without the detection performed by UE 301 in step 321, the intersystem change may cause potential error in the transferred PDU session and the mapped QoS flow, causing additional operation errors. The detected error is mainly due to the QoS rule and/or QoS flow are not synchronized between the UE and the network. Without the detection by UE 301 in step 321, the error would be propagated from EPS S1 mode to 5GS N1 mode and causes mis-operations and issues when the problematic QoS rules and/or QoS flows are used by the UE and the network.

FIG. 4 illustrates one embodiment of QoS flow description identified by a QoS flow identifier (QFI) as well as a QoS rule comprising a QoS rule identifier (QRI) and a QFI. The network can provide a QoS flow description IE to the UE, which comprises a list of QoS flow descriptions. Each QoS flow description, as depicted by 410 of FIG. 4, comprises a QFI, a QoS flow operation code, a number of QoS flow parameters, and a QoS flow parameter list. As defined by the 3GPP specification, a parameter identifier field is used to identify each parameter included in the parameter list and it contains the hexadecimal coding of the parameter identifier. For example, the following parameter identifiers are specified: 01H(5QI), 02H(GFBR uplink), 03H(GFBR downlink), 04H(MFBR uplink), 05H(MFBR downlink), 06H(averaging window), 07H(EPS bearer identity) (EBI). The parameter identifier EBI is used to identify the EPS bearer that is mapped to or associated with the QoS flow.

The network can also provide a QoS rule IE to the UE, which comprises a list of QoS rules. Each QoS rule, as depicted by 420 of FIG. 4, comprises a QoS rule identifier (QRI), a length of the QoS rule, a rule operation code, a default QoS rule (DQR) bit, a number of packet filters, a packet filter list, a QoS rule precedence, and a QoS flow identifier (QFI). Since QFI identifies a corresponding QoS flow, the QoS rule having the specific QFI is thus associated with the QoS flow through the same specific QFI. Further, since a QoS flow is mapped to an EPS bearer through EBI in the parameters list, a QoS rule can be associated to the corresponding EPS bearer through the QoS flow. Therefore, based on the QoS flow description IE and QoS rule IE, a UE can determine a QoS operation of a QoS flow/QoS rule and relationships with the associated EPS bearers. The UE can further detect any potential errors caused by the QoS operation and handle those errors accordingly.

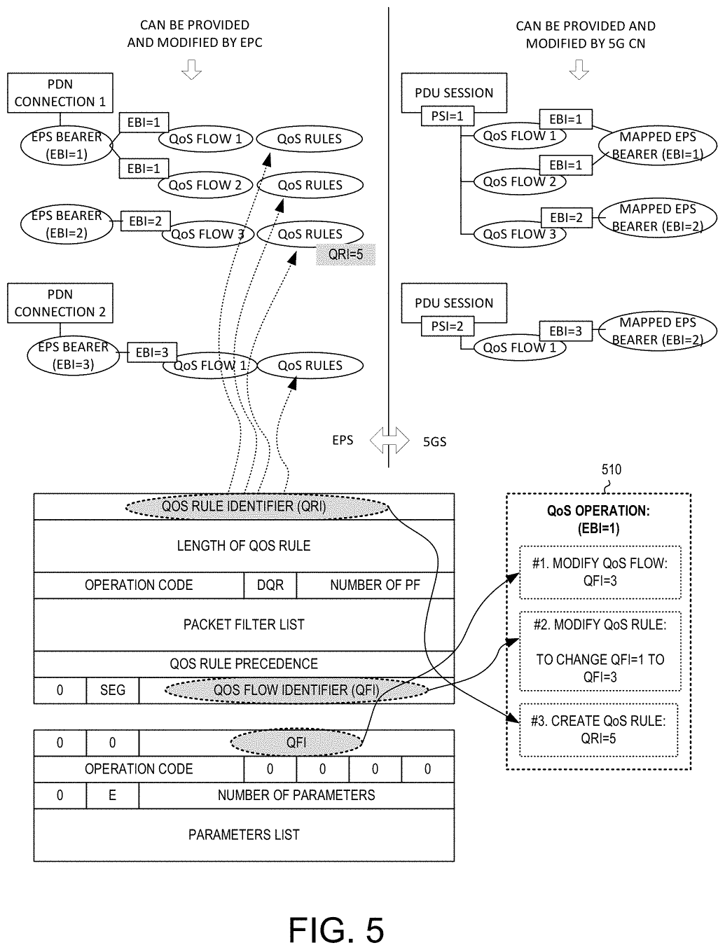

FIG. 5 illustrates embodiments of detecting various QoS operation errors during an ESM procedure and corresponding UE behavior. In the embodiments of FIG. 5, a UE is configured with multiple PDN connections, e.g., PDN connection 1 and PDN connection 2. Each PDN connection is further configured with one or multiple EPS bearers, and each EPS bearer is identified by a EPS bearer ID (EBI). For example, PDN connection 1 is configured with EPS bearers having EBI=1 and EBI=2, and PDN connection 2 is configured with EPS bearer having EBI=3. Each EPS bearer is also associated with a corresponding QoS flow, which is identified by a QoS flow ID (QFI). Each QoS flow contains one or multiple QoS rules, each QoS rule is identified by a QoS rule ID (QRI). For example, EBI=1 is associated with QFI=1 and QFI=2, EBI=2 is associated with QFI=3, and EBI=3 is associated with QFI=1. Note that EBI needs to be unique across all the PDN connections, while QFI only needs to be unique within each PDN connection. Upon intersystem change from EPS to 5GS, the PDN connections are transferred to PDU sessions, and the EPS bearers are mapped to corresponding QoS flows as depicted in FIG. 5.

In 4G EPS, a QoS operation can be performed by an ESM procedure (via an ESM message for an EPS bearer context request), e.g., the EPS bearer context is received in a PCO/ePCO IE in the ESM message. SGSM parameters, including QoS flow description IEs and QoS rule IEs, are carried in the PCO/ePCO. During the ESM procedure, as a general principle, only 5G QoS parameters related to the current EPS bearer been activated or modified are allocated and sent to the UE via PCO/ePCO. Otherwise, it implies the QoS rule and/or QoS flow information are not synchronized between the UE and the network. The error operation should be detected by the UE before intersystem change from EPS S1 mode to 5GS N1 mode happens and the UE should indicate such error to the network. Otherwise, the error would be propagated from EPS S1 mode to 5GS N1 mode and causes mis-operations and issues when the problematic QoS rules and/or QoS flows are used by the UE and the network.

FIG. 5 depicts different embodiments of the QoS operation errors during an ESM procedure for EPS bearer with EBI=1 (510). In a first embodiment #1, the ESM message is MODIFY EPS BEARER CONTEXT REQUEST message. The QoS operation is to modify or delete an existing QoS flow, however, the existing QoS flow is stored for another EPS bearer context different from the EPS bearer context being modified. For example, the ESM procedure on EBI1 tries to modify or delete a QoS flow having QFI=3, which is associated to EBI2. The UE shall include a Protocol configuration options IE or Extended protocol configuration options IE with a SGSM cause parameter set to SGSM cause #83 “semantic error in the QoS operation” in the MODIFY EPS BEARER CONTEXT ACCEPT message.

In a second embodiment #2, the ESM message is MODIFY EPS BEARER CONTEXT REQUEST message. The QoS operation is “Create new QoS flow description”, “Modify existing QoS rule and add packet filters”, “Modify existing QoS rule and replace all packet filters”, “Modify existing QoS rule and delete packet filters”, “Modify existing QoS rule without modifying packet filters” or “Delete existing QoS rule”, and the resultant QoS rule is associated with a QoS flow description stored for another EPS bearer context different from the EPS bearer context being modified. For example, the ESM procedure on EBI1 tries to modify a QoS rule of QFI1 and changing QFI1 to QFI3, but QFI3 is associated with another EPS bearer with EBI2. The UE shall include a Protocol configuration options IE or Extended protocol configuration options IE with a 5GSM cause parameter set to 5GSM cause #83 “semantic error in the QoS operation” in the MODIFY EPS BEARER CONTEXT ACCEPT message.

In a third embodiment #3, the ESM message is ACTIVATE DEFAULT EPS BEARER CONTEXT REQUEST or ACTIVATE DEDICATED EPS BEARER CONTEXT REQUEST message. The QoS operation is to create new QoS rule having a QRI, and there is already an existing QoS rule with the same QRI stored for an EPS bearer context different from the EPS bearer context being activated and belonging to the same PDN connection as the EPS bearer context being activated. For example, a QoS rule with QRI=5 already exist with EBI2, and ESM procedure on EBI1 tries to create a new QoS rule with QRI=5. Note that if a QoS rule with QRI=5 already exist with EBI3, then there is no QoS operation error. This is because EBI3 belongs to another PDN connection 2, and it is acceptable for different PDN connections to include QoS flows or QoS rules having the same QFI or QRI. The UE shall not diagnose an error, further process the create request and, if it was processed successfully, delete the old QoS rule. The UE shall include a PCO/ePCO IE with a 5GSM cause parameter set to 5GSM cause #83 “semantic error in the QoS operation” in the ACTIVATE DEFAULT EPS BEARER CONTEXT ACCEPT or ACTIVATE DEDICATED EPS BEARER CONTEXT ACCEPT message.

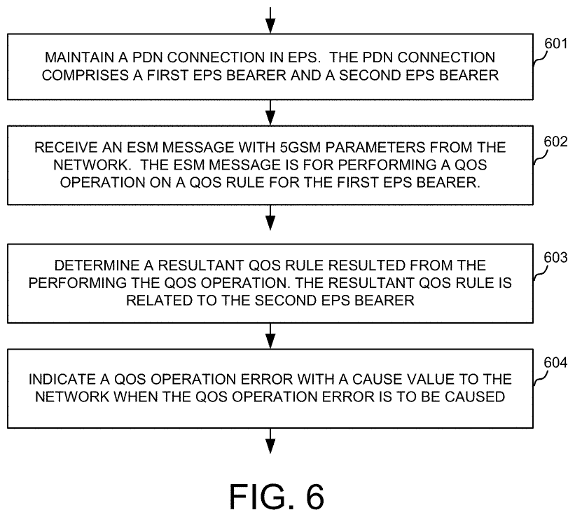

FIG. 6 is a flow chart of a method of handling QoS operation error during an ESM procedure from a user equipment (UE) perspective in accordance with one novel aspect. In step 601, a UE maintains a Packet data network (PDN) connection in evolved packet system (EPS). The PDN connection comprises a first and a second evolved packet system (EPS) bearers. In step 602, the UE receives an EPS session management (ESM) message with 5GSM parameters from the network. The ESM message is for performing a QoS operation on a QoS rule for the first EPS bearer. In step 603, the UE determines a resultant QoS rule resulted from the performing the QoS operation. The resultant QoS rule is related to the second EPS bearer. In step 604, the UE indicates a QoS operation error with a cause value to the network when the QoS operation error is to be caused.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
maintaining a Packet data network (PDN) connection by a user equipment (UE) in evolved packet system (EPS), wherein the PDN connection comprises a first and a second evolved packet system (EPS) bearers;
receiving an EPS session management (ESM) message with 5GSM parameters from the network, wherein the ESM message is for performing a QoS operation on a QoS rule for the first EPS bearer;
determining a resultant QoS rule resulted from the performing the QoS operation, wherein the resultant QoS rule is related to the second EPS bearer; and
indicating a QoS operation error with a cause value to the network when the QoS operation error is to be caused.

2. The method of claim 1, wherein the 5GSM parameters are included in a Protocol configuration options IE or an Extended protocol configuration options IE (PCO/ePCO) in the ESM message.

3. The method of claim 1, wherein the ESM message is an ACTIVATE DEFAULT EPS BEARER CONTEXT REQUEST message, an ACTIVATE DEDICATED EPS BEARER CONTEXT REQUEST message, or a MODIFY EPS BEARER CONTEXT REQUEST message.

4. The method of claim 1, wherein the QoS operation is for creating the resultant QoS rule that is associated to the second EPS bearer.

5. The method of claim 1, wherein the QoS operation is for deleting the resultant QoS rule that is associated to the second EPS bearer.

6. The method of claim 1, wherein the QoS operation is for modifying the QoS rule, and wherein the modification is to change a QoS flow ID (QFI) of the QoS rule such that the resultant QoS rule is associated to another QoS flow that is mapped to the second EPS bearer.

7. The method of claim 1, wherein the QoS operation is for creating the resultant QoS rule having a QoS rule ID (QRI) for the first EPS bearer, wherein the second EPS bearer has an existing QoS rule having the same QRI.

8. The method of claim 7, wherein the first EPS bearer and the second EPS bearer belong to the same PDN connection.

9. The method of claim 1, wherein the UE sends a PCO/ePCO IE with a cause value indicating a semantic error in the QoS operation.

10. The method of claim 1, further comprising:
performing inter-system change from EPS to 5G system; and
transferring the PDN connection to a PDU session, wherein EPS bearer context of the first and the second EPS bearers are mapped to QoS flows of the PDU session.

11. A User Equipment (UE) comprising:
a Packet data network (PDN) connectivity handling circuit that maintains a PDN connection in evolved packet system (EPS), wherein the PDN connection comprises a first and a second evolved packet system (EPS) bearers;
a receiver that receives an EPS session management (ESM) message with 5GSM parameters from the network, wherein the ESM message is for performing a QoS operation on a QoS rule for the first EPS bearer;
a QoS handling circuit that determines a resultant QoS rule resulted from the performing the QoS operation, wherein the resultant QoS rule is related to the second EPS bearer; and
a transmitter that sends a cause value to the network to indicate a QoS operation error when the QoS operation error is to be caused.

12. The UE of claim 11, wherein the 5GSM parameters are included in a Protocol configuration options IE or an Extended protocol configuration options IE (PCO/ePCO) in the ESM message.

13. The UE of claim 11, wherein the ESM message is an ACTIVATE DEFAULT EPS BEARER CONTEXT REQUEST message, an ACTIVATE DEDICATED EPS BEARER CONTEXT REQUEST message, or a MODIFY EPS BEARER CONTEXT REQUEST message.

14. The UE of claim 11, wherein the QoS operation is for creating the resultant QoS rule that is associated to the second EPS bearer.

15. The UE of claim 11, wherein the QoS operation is for deleting the resultant QoS rule that is associated to the second EPS bearer.

16. The UE of claim 11, wherein the QoS operation is for modifying the QoS rule, and wherein the modification is to change a QoS flow ID (QFI) of the QoS rule such that the resultant QoS rule is associated to another QoS flow that is mapped to the second EPS bearer.

17. The UE of claim 11, wherein the QoS operation is for creating the resultant QoS rule having a QoS rule ID (QRI) for the first EPS bearer, wherein the second EPS bearer has an existing QoS rule having the same QRI.

18. The UE of claim 17, wherein the first EPS bearer and the second EPS bearer belong to the same PDN connection.

19. The UE of claim 11, wherein the UE sends a PCO/ePCO IE with a cause value indicating a semantic error in the QoS operation.

20. The UE of claim 11, further comprising:
an inter-system handling circuit that performs inter-system change from EPS to 5G system, wherein the PDN connection is transferred to a PDU session, and wherein EPS bearer context of the first and the second EPS bearers are mapped to QoS flows of the PDU session.
